(19) United States
(12) Patent Application Publication
(10) Pub. No.: US 2004/0010699 A1
(43) Pub. Date: Jan. 15, 2004

(54) Secure data management techniques

(76) Inventors: Zhimin Shao, Beijing (CN); Wenbo Mao, Bristol (GB)

Correspondence Address: HEWLETT-PACKARD COMPANY, Intellectual Property Administration, P.O. Box 272400, Fort Collins, CO, 80527-2400, US

(21) Appl. No.: 10/360,826

(22) Filed: Feb. 6, 2003

(30) Foreign Application Priority Data
Feb. 7, 2002 (GB) 0202799.3

(51) Int. Cl. G06F 11/30

(52) U.S. Cl. 713/189

(57) ABSTRACT

A method of providing to an individual (28) selected personal data (136) relating to an entity (26) is described. The method comprises: encrypting a plurality of fields (132) of personal data, each data field being encrypted with a unique cryptographic key; storing each of the encrypted data fields (134) in a data record (130) at a central location such as a data storage service provided by an Internet Service Provider; and supplying a specific cryptographic decryption key associated with a respective one of the unique cryptographic keys which relates to a selected field (132) of the entity's personal data to the individual, such that the individual is only able to decrypt the selected field of the entity's personal data by accessing the stored data record (130).

### TECHNICAL FIELD

The present invention relates to improvements relating to secure data management techniques using cryptography. It relates particularly, but not exclusively, to the secure storage and retrieval of data over open networks such as the Internet. The invention also relates to the problem of key storage and management in a secure data management system and has particular application in mobile data management applications.

### BACKGROUND ART

A computer network typically includes one or more server computers which run administrative software that controls access to the network and to resources such as printers, file systems, disk drives and CPU (Central Processing Unit) time. A well-known protocol for the sharing of file systems (that is, files, directories, folders, and the information needed to locate and access these items) on a network is Sun Microsystem's Network File System (NFS). This system allows users on client computers to access remote files and directories on a network as if they were local files and directories.

The management of the security of the network is usually carried out by a network administrator who performs tasks such as adding and removing users from a list of authorised users, overseeing password protections, and other network security measures. In order to accomplish these tasks, the network administrator is given the status of a “superuser” and can use the command “su” to become any user. This results in the network administrator having access to all of the users' data and passwords.

One disadvantage of the Network File System is that it assumes a strong “trust model”. That is, a user trusts the remote file system server(s), the network, and the network administrator with his or her data. This may pose risks to the security of the system if, for example, the network administrator is not a trustworthy person. In addition to the abovementioned security problem, NFS provides only a minimal amount of authentication of a user. When a user requests information from a server, the server receives from the client computer the “user id” of the user requesting the data. The server then checks whether that user is allowed to access the file containing the data. It is possible for a user to change his user id on the client computer, or to modify the client computer so that a different user id is provided with the data request. This will enable him to manipulate data that does not belong to him, and also to modify certain access privileges (such as read, write and delete privileges) to prevent, or to allow, other users access to this data. Anyone who gains access (or guesses) the network administrator's password will also be able to become any user, and will therefore be able to manipulate that user's data along with their file privileges.

A further disadvantage of the Network File System is that a record has to be kept of the access privileges of each and every user. One means for maintaining this information is by the use of an access control matrix. An access control matrix specifies the data that a user can access, and what kinds of access are allowed. The rows of the access control matrix represent the different users, and the columns represent data objects such as files. Each matrix element indicates what type of access a user has with respect to the given object. For example, a user by the name of “WU” may have permission to read, write and delete the file “Public_data.doc”, and yet only be permitted to read the file “Private_data.doc”.

The WU row of this matrix would contain the authorities “read”, “write” and “delete” in the “Public_data.doc” column, and the authority “read” in the file “Private_data.doc” column. It is necessary in such a system to have a predetermined knowledge of the users and their rights. If a new user wishes to access information they first have to go through a registration procedure which may take some time and is dependent on the superuser setting up their rights in the matrix. Although this type of matrix is a straightforward means of describing access privileges, it becomes inefficient in practice if there are many users and many files.

A particular disadvantage of the storing and access of data on a computer network is that the method by which the data is stored and accessed is dependent upon the operating system used. For example, NFS works with the Unix operating system to accomplish the tasks of file system access and control, whereas the Microsoft Windows family of operating systems use a system known as “file and printer sharing” to accomplish the same task. Another disadvantage of such storage systems is that they are only usually employed in relatively large companies that can afford to implement vast computer networks. Self-employed workers or sole practitioners will rarely have access to such a system for storing (and for permitting other third parties to access) their data. However, due to the sharp increase of use of the Internet in recent years, this problem has been ameliorated to some extent by Internet Service Providers (ISP's). Some ISP's offer services which enable a user to place data on a server so that it may be accessed by different users via the Internet. Access to data stored with an ISP is typically controlled by the use of passwords. Passwords enable checking of the identity of a user attempting to log in to the ISP either to store or to retrieve data, and a user who does not have the correct password will not be allowed to access the data.

The basic system of passwords provides a certain level of security for data access, but unfortunately passwords can be eavesdropped, stolen, guessed or even forgotten! A further drawback of a password-based system is that a user who does have the correct password will usually be able to access all the data stored with the ISP which belongs to a particular user. A user who wishes to store large amounts of data with an ISP, or who wishes to permit some users to access a portion of the data while refusing access to others to the same portion of data, will have to put in place a more complicated and cumbersome password system. Provision for a complex password system may not be provided by the ISP or, if it is provided, it may not be provided as part of a basic data storage package and may therefore prove very expensive for the owner of the data.

As well as data access provisions, data privacy and trust are also important issues with Internet-based data storage services. Studies made with regard to this subject have indicated that the majority of customers do not trust ISP's to handle their data properly. This is because it is possible in theory for employees of the ISP to gain unauthorised access to the stored data. This problem may be partially overcome by compressing data that is to be stored, but it is a very simple operation to decompress and thereby to read the data. Data owners are well aware of these problems and wish to see proper handling of their personal information. More specifically, they wish to control who can see their information and for what purpose that information is going to be used. There is therefore a need for a system of sharing data that provides an additional level of security than that provided by existing systems, and one that is not operating system dependent. A system that meets these criteria also needs to be fairly cheap to implement and easy to use.

Problems with secure access and storage of data with ISP's may be partly solved by encrypting the data to be stored using traditional cryptographic techniques. In traditional cryptography, the transformation used to encrypt the data typically involves an algorithm and a key. The process of transforming (i.e., encrypting) data is to apply the encryption algorithm to the data, the key being used as an auxiliary input to control the encrypting process. The reverse operation (i.e., decrypting) is carried out in a similar manner. Whilst the encryption algorithm may be a publicly known algorithm, some or all of the key information must be kept secret.

For some types of known encryption algorithm, the same key is used for both encryption and decryption of data. This is known as private-key or symmetric cryptography. For other types of known encryption algorithm, the keys used for encryption and decryption of data are different. This type of encryption is known as public-key or asymmetric cryptography. In public-key cryptography, each user has a public key and a private key: the public key is made public, while the private key remains secret. Encryption of data is performed using a public key, and decryption of encrypted data is performed with a private key.

In private-key (symmetric) cryptography the main challenge is getting both the sender and receiver of the data to agree on the secret key without anyone else finding out. If they are in separate physical locations, they must trust a courier, a phone system, or some other transmission medium to prevent the disclosure of the secret key. Anyone who overhears or intercepts the key in transit can later read, modify and forge all data encrypted using that key. Because all keys in a private-key cryptography system must remain secret, private-key cryptography often has difficulty providing secure management of keys, especially in open systems with a large number of users.

The key management problem of private-key cryptography lead to the development of public-key cryptography by Diffie and Hellman. As described previously, all communications thus involve only public keys, and no private key is ever transmitted or shared. It is therefore no longer necessary to trust the security of some communication means. A disadvantage of this type of system is that the more users there are, the more private keys there will be, and the more likely it is that one of the private keys will be lost. If this occurs, then the whole of the encryption system could be compromised.

Published International patent application WO 95/22793 (Infosafe Systems, Inc) describes a system for storing encrypted information wherein a different and unique key is used to encrypt different segments of information stored on a storage medium (such as a compact disk), rather than at a central location. The unique encryption and decryption keys are defined (at least in part) by data stored on the storage medium such as “file directory” information containing the identity, length, location and date of each file.

The system includes a decryption controller which communicates with, for example, a CD-ROM reader. The key information used to determine the decryption keys is stored locally to the system, and all of the keys used in the system are created and maintained in the decryption controller itself. That is, the decryption keys are not transmitted to a user who wishes to access data on the CD-ROM: this is a significant object of the Infosafe invention. The result of this significant feature is that the decryption of the encrypted data is carried out on the system itself, by the decryption controller, without any intervention by the user. Control over who accesses the encrypted information on the disk is therefore not determined by whether or not the user has in his possession the correct decryption key(s).

It is an object of the present invention to overcome or substantially reduce at least some of the aforementioned problems.

### SUMMARY OF THE INVENTION

The present invention resides in the appreciation that many of the above described problems with the secure storage and access of data in a network environment can be substantially reduced by the combined use of relatively simple cryptographic techniques to store data centrally, and use of a higher resolution of data encryption/decryption to give better data accessibility and control.

More specifically, according to one aspect of the invention there is provided a method of providing to an individual selected personal data relating to an entity, the method comprising: encrypting a plurality of fields of personal data relating to the entity, each data field being encrypted with a unique cryptographic key; storing each of the encrypted data fields in a data record at a central location accessible to the entity and the individual; and supplying to the individual a specific cryptographic decryption key associated with a respective one of the unique cryptographic keys which relates to a selected field of the entity's personal data, such that the individual is only able to decrypt the selected field of the entity's personal data by accessing the stored data record.

The advantages of the method of the present invention are firstly that the entity has a secure place in which to store personal data, and secondly that the entity also has complete control over who is able to access personal data, and which fields of the personal data an individual (or third party, namely, a party other than the entity) may access. Access control to data in the present invention is achieved by encrypting each item (or field) of personal data using different key information, and by only providing third parties with the key information which is needed to decrypt the data fields the entity has permitted them to access. As the personal data is stored at a central location accessible both to the entity and the individual, the supplying of decryption keys from the entity to the individual is required, otherwise the individual would not be able to access the personal information. Additionally, once the individual has received the decryption key(s) for decrypting the encrypted information, he has complete control over when the personal data is decrypted. For example, he may decrypt the information at once as soon as he receives the appropriate key(s), or he may hold on to the decryption key(s) for a period of time before he decrypts the data.

The entity is preferably the owner of the data, and so will be referred to hereinafter as the data owner.

The terms individual and third party are interchangeable and are intended to cover the recipient of the data whether they are an individual person, an organisation, or a computer if the method is carried out automatically.

Unlike the two aforedescribed traditional encryption techniques (i.e. public-key and private-key encryption) and the Infosafe system, in the present invention the key information preferably comprises at least a public key which is accessible to both the owner of the data and the third party, and a master key the details of which are known only to the data owner. The master key is preferably used in order to generate the public key. The encrypting step therefore preferably also comprises the step of generating the public key.

It is to be appreciated that the step of deriving the public key from the master key is a highly significant feature of the present invention. This is because the owner of the data is in charge of his own master key which he uses to encrypt his own personal data. This provides him with a strong incentive to keep his master key secure and thus keep his encrypted personal data secure.

More specifically, the advantage of using the master key in the public key generation step is that a third party will not be able to duplicate the public key(s) without knowing the master key. As only the data owner knows the details of the master key (i.e., how long the key is, whether it is a prime number or a random number, etc), unauthorised third parties will not be able to access the public key(s), and will therefore not be able to access the data that has been encrypted using this key(s). A further advantage is that unlike conventional public-key encryption where each user has a public key and a private key, the present invention only requires the use of one private or master key. This leads to a more secure system because the more keys there are in a cryptography system, the more chance there is of one of the private keys being lost. The feature of generating the public key(s) as and when they are required also has significant advantages in relation to the management of keys. More specifically, the generation of keys requires less memory storage than the alternative of public key storage and retrieval which, for example, in mobile applications is at a premium.

The public key is preferably a unique key the value of which changes each session, where a session is defined as the storage of an individual field of encrypted data at the data store. As a different public key is generated for each new session, the public key is also known as a “session key”. As a unique session key is used to encrypt each individual field of data stored in the data store, a recipient in possession of one particular session key will not be able to access other encrypted data which is stored at the data store.

The master key may be protected by a password so that it may not be read by a third party if it should accidentally fall into the wrong hands.

The session key may be stored in the same data store used to store the encrypted data, or in a different data store. Wherever the session key is stored, it is preferable that it is encrypted beforehand. The session key may be encrypted using the master key. Again, the advantage of encrypting the session key with the master key is that only the owner of the data knows the size and value of the master key. Thus only he has the information to decrypt the session key. This is important if the session key is stored in a public data store along with data which has been encrypted using the session key.

The method may further comprise the step of generating a master key if the master key does not already exist.

The generation of a unique session key preferably involves a method which generates long series of different keys, in order to maximise the security of the method. The preferred methods of generating session keys are hash functions, or random functions (pseudo or real). Most preferably the output values of these functions are used directly as the session key. However, any other method that generates a large series of unique numbers may be used. For example, a unique number may be generated using the system clock of a computer if the granularity of the clock reading is sufficiently fine.

A hash function H generates a hash value h from at least one input number M. The important point about a hash value is that it is nearly impossible to derive the original input number(s) without knowing the data used to create the hash value. For example, an input number M has the value 28,948. The hash function performs the function M*99. The hash value h resulting from the hash function is 2,865,852. It is easy to see that it is hard to determine that the hash value 2,865,852 arises from the multiplication of 28,948 by 99. However, if the multiplier 99 (i.e., the hash function H) is known, then it is very easy to calculate M.

The hash function may be a secure hash function H that operates on a data element M of arbitrary length and returns a fixed length hash value, h.

The hash function may be used to compute the hash value of the combination of the session number and the master (secret) key. The session number is advantageously an integer that changes for each new session. Most preferably the session number is generated by a counter that is incremented (either positively or negatively) each time a new session commences. After the session number has been generated, it may be stored in the data store for later re-use. Alternatively, it may be stored elsewhere until it is required for re-use.

In an alternative method, the master key may be used as the seed for the random (or pseudo-random) number generation. The random and/or pseudo-random function method of generating the session key may also require the session number as a seed for the random number generation. The session number may be generated by incrementing a counter each time a random number (or pseudo-random number) is generated. Again, as the master key is known only to the owner of the data, this reduces the chances of an unauthorised third party being able to regenerate the session key and thus access the data that has been encrypted using this session key.

Both the master and the session key are preferably integers, and most preferably each key is less than 100 bits long. So the master and session keys will have up to 2¹⁰⁰ different combinations and it should therefore be virtually impossible for a third party to work out the value of the keys.

The size of the master and session keys are not dependent upon the amount of data to be decrypted. A system utilising the method of the invention is therefore breakable in theory. What makes the system usable in practice is that the person trying to break the encryption code must use a large amount of computational resources in order to access a relatively small amount of data, and must repeat this many times to obtain a significant result. This makes the process of breaking the encryption to get significant results impractical and in fact unfeasible.

The composition of a data field depends upon the area of application of the method of the invention. For example, if the invention is to be used to securely store information for Internet shopping the data field may be data such as a credit card number. If the invention is to be used to securely manage a portfolio of images, then a data field may be a digital image of that portfolio. A collection of data fields may form part of a larger collection of data which may be linked by a common theme. The division of a data record or a collection of data enables each individual field of data to be encrypted using different key information. This means that if a third party obtains key information for decrypting say, an encrypted credit card number, he will not be able to decrypt a password which has been encrypted using other key information, as the former and the latter key information will never be identical. This fine-grain control of access to certain data fields which form part of a data record is not provided by prior art network storage solutions.

In order that the encrypted data may be identified and accessed when it is in the data store, each data element preferably has an index value associated with it. The index value may for example be a two-character code or an alphanumeric code of a different length. An example of a data record having a plurality of data fields and associated index values is shown below.

| Data Element | Index Value |
|---|---|
| [Address] | [ad] |
| [Credit card number] | [cc] |
| [Password] | [pd] |

The index values are preferably sent to the data store with the encrypted data. This allows the data store to map each index value to its associated encrypted data element, and also saves the data owner the trouble of having to store large numbers of index values himself. The index values may then be subsequently retrieved by name. For example, an index value for a credit card may be “cc” or “ccn”. If the data owner has a huge amount of personal data in the data store, he may not be able to remember each and every index value. Submitting a request to the data store for the index value relating to his credit card using the code “credit card” solves this problem.

The data storing step preferably includes the step of transmitting the data to the data store. This transmitting step may be carried out via a secure link. If the data is to be sent to the data store via the Internet, then the secure link may be provided by the Secure Sockets Layer (SSL) protocol. This protocol provides data encryption during a communications session, optional authentication of a client, and server authentication using public key encryption. The advantage of transmitting the data to the data store using the SSL protocol is that the integrity of every communication is preserved: SSL generates a warning if even a single character of information has been changed between the server and the user's Web browser by an unauthorised third party. This technology is currently incorporated into all major Web browsers and Web servers. If the data is to be transmitted to the data store using a telecommunications network, then the secure connection may be established using the Wireless TLS protocol.

In addition to the encrypted data, the index value associated with the data may also be transmitted to the data store via a secure link.

In order to further improve the security of the method, the step of storing encrypted data in the data store may include the further step of authenticating the identity of the party that is placing the data in the store. The authentication step may be implemented using a password-based scheme, by voice recognition, or by any other suitable method.

Preferably the request for one or more data fields is carried out by, for example, electronic mail, a telephone call, or even by facsimile. Alternatively, the request may be made via a software program such as a Web browser. If the third party requesting the data knows the index value of the data he is requesting, then the requesting step may further include the step of transmitting the index value along with the data request. However, if the third party does not know the index value, the data can be requested by name. For example, John (the third party, may phone Paul (the data owner) and ask for John's credit card number and full address. Paul may then forward John the appropriate index values “cc” and “ad” so that Paul can send them to the data store so that the data fields can be identified and retrieved.

For some applications of the method, the encrypted data and the session key may be sent automatically to the recipient without an explicit request having been made in which case the step of explicitly requesting data is optional. This may occur if, for example, the third party requesting the data makes the same request at the same time each day.

Where the data storage system is required to store a large amount of encrypted data, it may be impractical to store the large number of unique session keys that have been used to encrypt the data. It may therefore be more practical to regenerate the session keys as and when they are required. This also solves the key management problem which deals with the storage of keys as well as their secure generation and distribution.

The step of supplying a specific cryptographic key for subsequent data decryption may therefore preferably include the step of regenerating the session key. This solves the aforementioned problem of having a large number of private keys, one or more of which may be lost thereby compromising the security of the whole encryption system.

Regeneration of the session key involves carrying out the opposite process by which the session key was generated. For example, where a secure hash value has been used as the session key, then the regenerating step comprises retrieving the number of the session and the master key to recreate the hash value. Where a pseudo-random value has been used as the session key, then the regenerating step comprises retrieving either the session number or the sequence number of the random number and the master key to recreate the pseudo-random value. The session key cannot be regenerated unless the master key is obtained. It is therefore in the interests of the data owner to look after his master key unless he wishes his data to be decrypted by an unauthorised party.

It is very important for a secure data storage system that the management of keys is secure as in practice most attacks on such systems will probably be aimed at the key management system, rather than at the cryptographic algorithm itself. The advantage of the regenerating step of the method is that no key management as such is required as the session keys are regenerated as and when they are required. The only key that needs to be “managed” is the data owner's master key. This solves the problem of lost keys, and the problem of the stealing of master keys.

Regeneration of the session key is preferably carried out by the data owner. This ensures the highest level of security and gives the data owner control over the most significant means for accessing the centrally stored personal information.

However, if only small amounts of data are to be stored at the data store, then the key management problem will not be so great. In an alternative aspect of the present invention the step of supplying the session (cryptographic) key comprises the step of retrieving the session key from wherever it has been stored. Where the session key has been stored in encrypted form, the retrieving step preferably also includes the step of decrypting the session key.

When the session key has either been regenerated or retrieved, it is preferably sent to the third party. The encrypted data may be sent to the recipient with the session key. Alternatively, the third party may request that the session key and the encrypted data is sent to another user, in which case the data requesting step will further include the step of providing details to the data owner of the other user.

The sending step is preferably carried out using an open, i.e. unsecured, network connection. However, if security is of paramount importance, then this step may be carried out using a secure connection.

The encrypted data may then be decrypted using the session key. The decrypting step may be carried out as soon as the third party receives the session key and the encrypted data, or the third party may store the key and the data for decryption at a later date.

It is important to note that any of the steps of the method may be carried out automatically without any human intervention. For example, some or all of the steps of the method may be carried out by machines such as computers, mobile phones, or by personal digital assistants.

According to another aspect of the invention there is provided a method of securely storing data in, and retrieving data from, a data store, the method comprising: encrypting a data record which comprises a plurality of data fields, each data field being encrypted using different key information; storing the encrypted data record in the data store; making a request for at least one of the data fields; obtaining the key information for the requested at least one data field; and sending the obtained key information and the requested encrypted data field(s) to a recipient so that the at least one data field of the data record may be decrypted.

The present invention also extends to a system for providing to an individual selected personal data relating to an entity, the system comprising: an encrypting module for encrypting a plurality of fields of personal data, each encrypted field being encrypted with a unique cryptographic key; a data store provided at a central location accessible to the entity and the individual for storing each of the encrypted data fields in a data record; and a communications module for supplying a specific cryptographic decryption key associated with a respective one of the unique cryptographic keys which relates to a selected field of the entity's personal data to the individual such that, when the stored data record is accessed by the individual, the individual is only able to decrypt the selected field.

The key generation means may comprise a random number or a pseudo-random number generator. The pseudo-random number generator may be a BBS (Blum, Blum and Shub) generator.

The data storage means is preferably provided on a server computer. An example of such a data store is the facility operated by an Internet Service Provider (ISP). The data may actually be stored on the server, or may be stored on a database local to, or remote from, the server. Alternatively, the encrypted data may be stored on a different server which may be either local to, or remote from, the server.

There may also be provided a data carrier for implementing the encryption means and/or decryption means for use with the embodiments of the invention as described above.

Another aspect of the present invention resides in a system for providing to an individual/third party selected personal data relating to an entity, the system being provided at a central location accessible to the entity and the individual/third party and comprising: a communications module for receiving a plurality of encrypted fields of personal data, each encrypted field being encrypted with a unique cryptographic key; and a data store for storing each of the encrypted data fields in a data record, wherein the communications module is arranged, in response to a request from the individual/third party for specific encrypted information, to retrieve the required data field and transmit the same to the individual/third party for decryption using the field specific cryptographic key that has previously been sent to the individual.

### BRIEF DESCRIPTION OF DRAWINGS

Presently preferred embodiments of the present invention will now be described by way of example only with reference to the following drawings:

FIG. 1 is a schematic diagram showing a suitable system for securely storing and accessing data according to the presently preferred embodiments of the invention;

FIG. 2 is a flow diagram showing an overview of the process of encrypting and storing data according to the presently preferred embodiments of the invention;

FIG. 3 is a flow diagram showing the process of requesting and retrieving stored encrypted data according to the presently preferred embodiments of the invention;

FIG. 4 is a schematic representation of a data record having a plurality of data fields;

FIG. 5a is a flow diagram showing the process of encrypting and storing data according to a first embodiment of the invention;

FIG. 5b is a flow diagram illustrating the steps involved in retrieving encrypted data according to the first embodiment of the invention;

FIG. 6a is a flow diagram showing the process of encrypting and storing data according to a second embodiment of the invention;

FIG. 6b is a flow diagram illustrating the steps involved in retrieving encrypted data according to the second embodiment of the invention;

FIG. 7a is a flow diagram showing the process of encrypting and storing data according to a third embodiment of the invention;

FIG. 7b is a flow diagram illustrating the steps involved in retrieving encrypted data according to the third embodiment of the invention;

FIG. 8 is a schematic block diagram showing the use of the first and second embodiments of the invention to retrieve encrypted location information;

FIG. 9a is a schematic block diagram illustrating the use of the first and second embodiments of the invention for the encryption and storage of digital images; and

FIG. 9b is a schematic block diagram showing the use of the first and second embodiments of the invention for the accessing of encrypted digital images.

### DESCRIPTION OF PREFERRED EMBODIMENTS

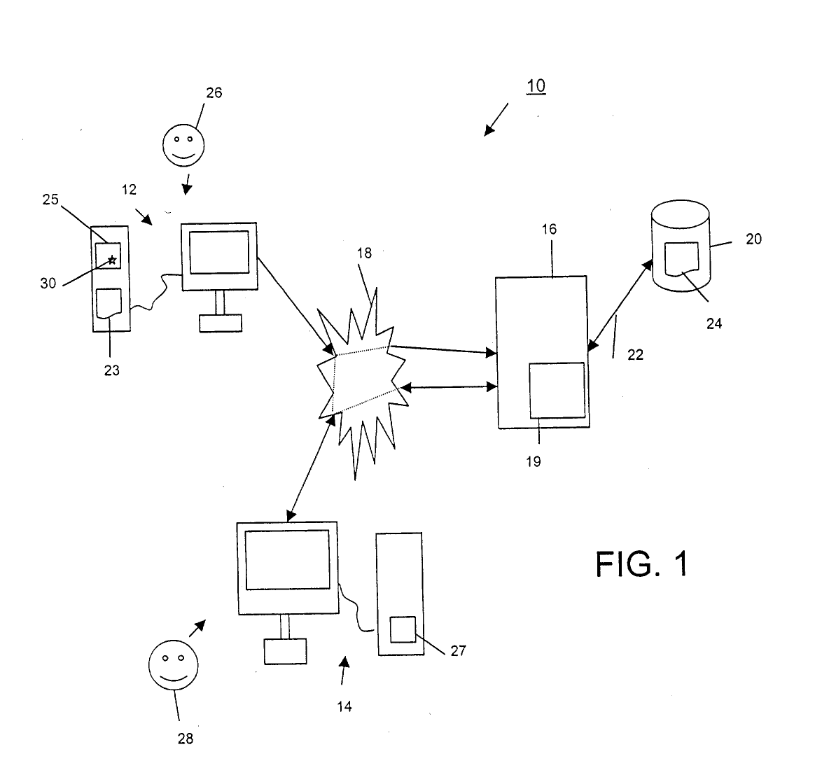

Referring now to FIG. 1, there is shown a client-server system 10 which is used for implementing the presently preferred embodiments of the invention. The client-server system 10 comprises a first client computer 12 and a second client computer 14 which are both connected to a server 16 via the Internet 18. The server 16 is arranged to host a data storage service 19, and the server is connected to a central database 20 by way of a further connection 22. The data storage service 19 provides a central service facility for storing data which is easily accessible via the Internet by a data owner 26 and a third party 28.

The above described system 10 functions in three different stages in order to provide to the third party 28 specific data which relates to the data owner 26.

In the first stage, when the data owner 26 wishes to securely store data at the data storage service 19, he generates key information and encrypts his data 23 with the key information using encryption software 25 that resides on his client computer. He then sends the encrypted data 24 to the data storage service 19 whereupon it is stored at the central database 20. As the data owner may wish to retrieve and decrypt his own encrypted data 24, the encryption software 25 also has the functionality to decrypt data. The encryption software 25 includes in two of the three embodiments a session number generator 30 such as a counter which is arranged in combination with the encryption software 25 as described hereinafter to generate key information.

In the second stage, when the third party 28 wishes to access specific data, he submits a request for this specific data to the data owner 26. If the data owner 26 agrees to the third party's request, he generates key information that relates only to the specific required data and sends this information to the third party 28 along with an identifier of a data storage location for the required data.

The third stage involves the third party 28 sending to the server 16 the index value and information identifying the data owner 26, retrieving the specific requested data from the data storage service 19, and decrypting the data 24 with the key information that was used to encrypt the data 23. Decryption is carried out with decryption software 27 that resides on the third party's client computer 14 using the key information. Each of these three stages is now described in greater detail.

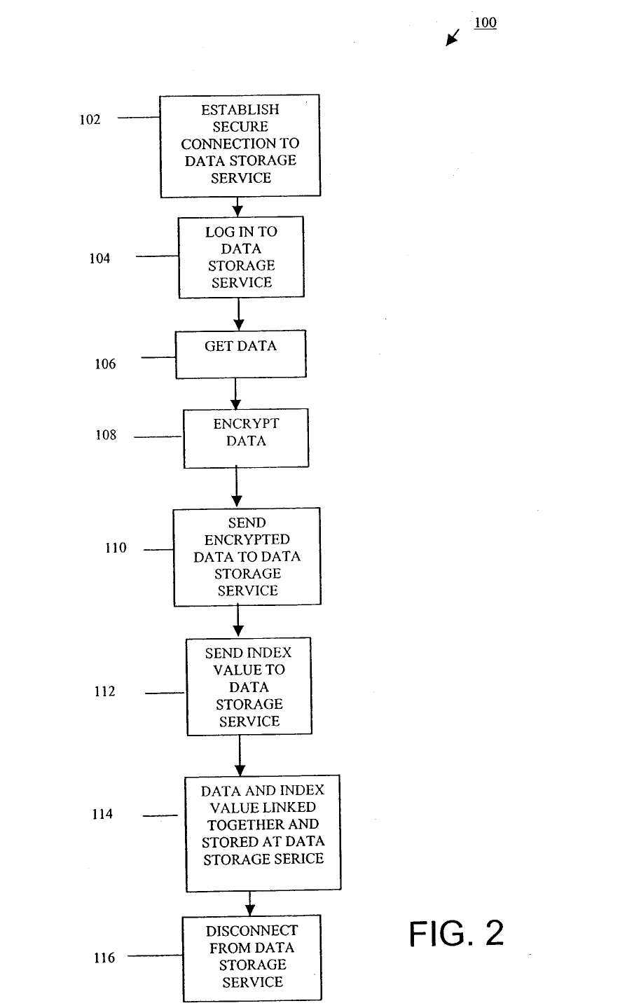

An overview of a method 100 for securely storing data at the data storage service 19 (the first stage) is shown in FIG. 2 and is now described. The method 100 commences with the owner of the data 26 establishing at Step 102 a secure connection between the client computer 12 and the server 16 which hosts the data storage service 19. The data owner 26 then logs in at Step 104 to the data storage service by providing a password to confirm his or her identity. If the data owner 26 is using the data storage service 19 for the first time, then he or she registers with the service in order to receive a password to access the service. This registration process is a well-known process that is used for most Web-based services and so will not be discussed further.

In the next Step 106 of the method 100, the data owner 26 retrieves the unencrypted data 23 that he/she wishes to store with the data storage service. The unencrypted data 23 may be kept on the data owner's client computer 12, or on a non-networked computer, a CD-ROM, or floppy disk etc. The data owner 26 then encrypts at Step 108 this data 23 using the encryption software 25 and the key information. The method by which the data is encrypted and the key information is generated will be explained in detail later. Steps 102 and 104 and Steps 106 and 108 may be interchanged so that the data owner encrypts the data before logging on to the data storage service 19. Alternatively, if data is already in encrypted form then Step 108 does not have to be carried out.

At Step 110, the encrypted data 24 is transmitted to the server computer 16 via the Internet, whereupon it is stored as a data record at the data storage service 19. In addition to the encrypted data 24, an index value I that is used to identify the encrypted data is sent to the storage service at Step 112. The storage service 19 stores the encrypted data 24 and the index value in the data record and maps the given index value I to the encrypted data at Step 114. The data owner 26 may then disconnect at Step 116 from the data storage service 19, or he may remain connected to the service 19 should he wish to store further encrypted data 24, disconnecting at Step 116 once this further encrypted data has been stored.

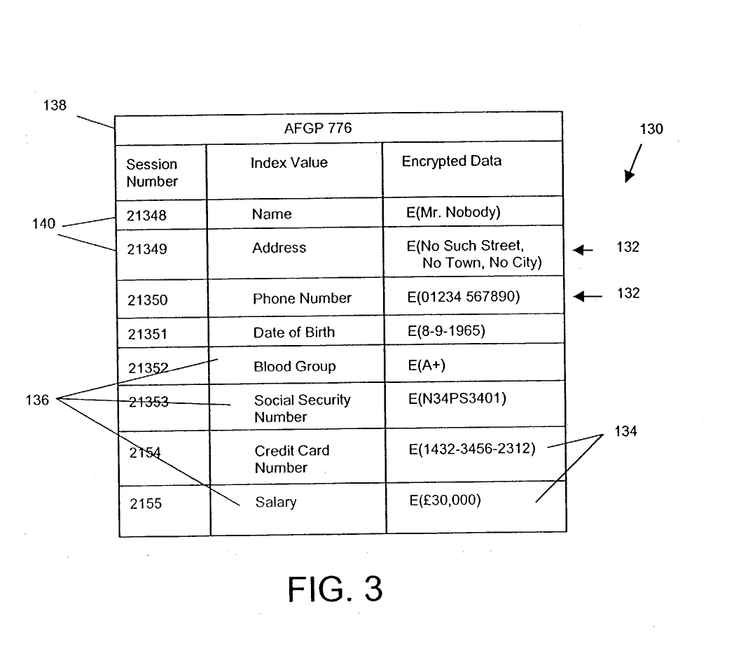

Referring now to FIG. 3 there is shown a personal data record 130 of the data owner 26. The record is split into a plurality of fields 132 which each relate to a specific type of information. Each field 132 contains an encrypted data segment 134 and a corresponding identifier 136. The record 130 also has a unique identifier number 138 which can be used to locate the record and link it to a password protection mechanism which needs to be passed through before editing of the record 130 is permitted. Furthermore, each field has a unique session number 140 which is used for encryption/decryption of the data (the way in which the session number 140 is used is described later). It is to be appreciated that whilst the index value has been shown as the field name for ease of understanding, in practice this may simply be a number the relevance of which to a respective type of information is only known to the data owner 26.

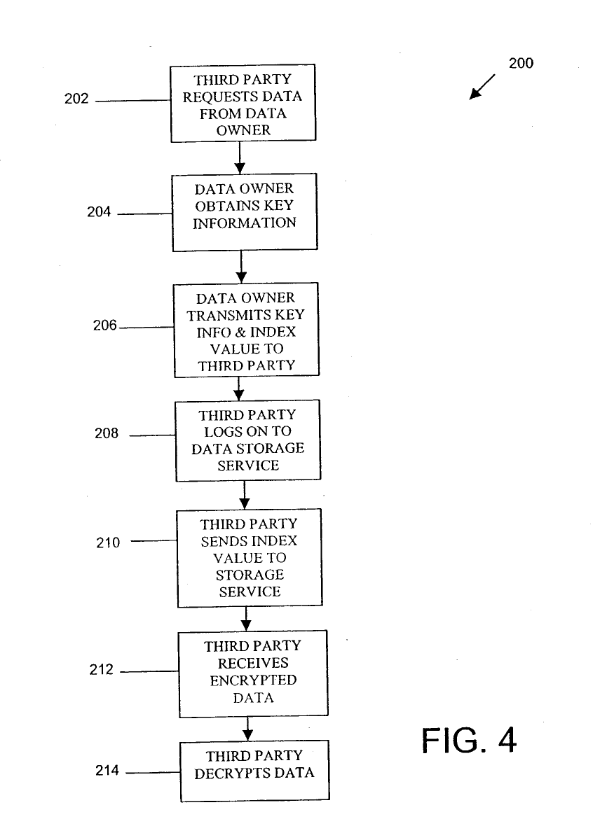

FIG. 4 shows the steps of a method 200 whereby a third party 28 requests data (second stage) and accesses (third stage) the requested data that is stored at the data storage service 19. At Step 202 the third party 28 requests specific personal data 23 from the data owner 26. Upon receiving the request for the specific personal data the data owner 26 obtains at Step 204 the key information that was used to encrypt the relevant field 132 of his personal data record 130. The data owner 26 then transmits at Step 206 this key information to the third party 28, along with the associated index value I( it is not necessary for this step to be carried out using a secure connection between the data owner 26 and the third party 28). Also, where multiple fields of the personal data need to be sent to the third party 28, a corresponding number of sets of key information are sent together with their respective index values I.

To access the encrypted data 24, the third party 28 logs on at Step 208 to the data storage service 19 and transmits at Step 210 the appropriate index value I to the data storage service in order to identify which field 132 of the data record 130 he would like to access. If the third party is using the storage service for the first time, then it may be necessary for him to register with the service in order to access data stored thereon. Such a registration process is well-known and will therefore not be discussed further.

If the third party is authorised to access the data owner's personal data record 130, the data storage service sends at Step 212 the encrypted data to him. Now that the third party has the encrypted data 24 in his possession, he decrypts at Step 214 the encrypted data 24 using the key information and the decryption software 27.

Three different encryption/decryption techniques which are used with the above described embodiment of the present invention are now described in detail, each one relating to a new embodiment of the present invention.

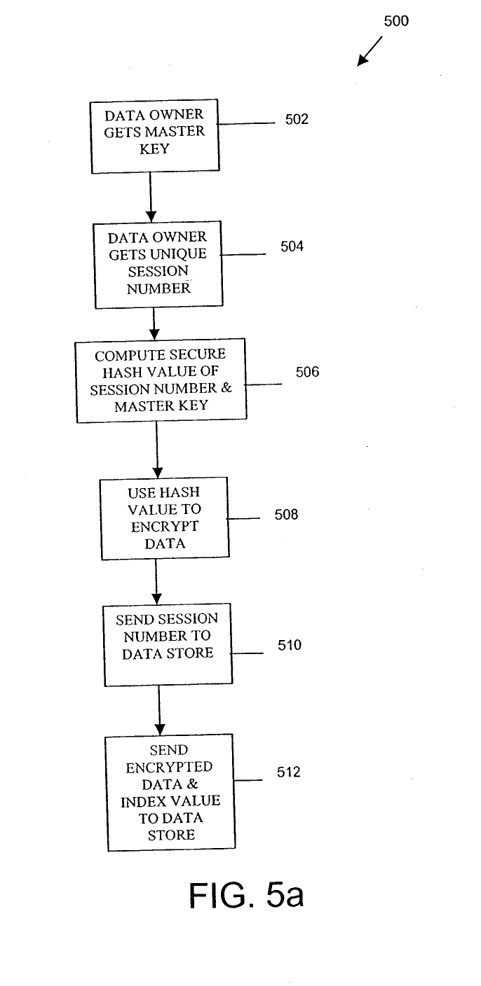

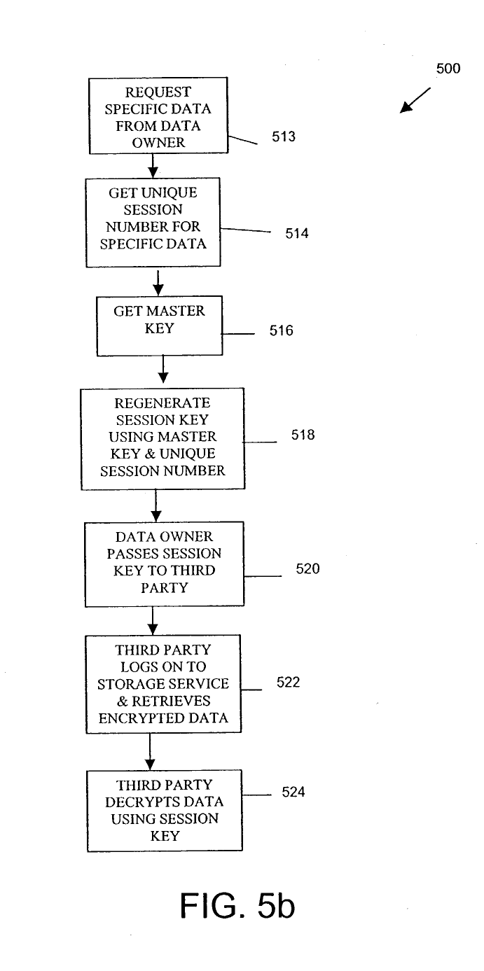

A first embodiment of the present invention utilising a first encryption/decryption technique whereby the session key is regenerated is now described with reference to FIGS. 5a and 5b respectively. This embodiment is referred to hereinafter as the ‘secure hash method’ as it utilises a hash function. As discussed previously, in order to encrypt the data 23 the data owner requires key information. This first encryption technique (and the techniques which follow) requires the data owner 26 to have a master key, the details of which are kept secret. This is imperative as, if the details of the master key become known to anyone other than the data owner, the security of the all of the data owner's encrypted data 24 stored with the data storage service 19 may be compromised.

The first step of the secure hash method 500 involves the data owner 26 retrieving at Step 502 his master key. If the data owner 26 does not already have a master key, then one can be generated for him by the encryption software 25. Next, the data owner 26 gets at Step 504 the number 140 of the current session. This step is taken each time the data owner 26 wishes to store a new field of encrypted data 24, so that the session number 140 for each session (and therefore each field of data 24) is unique.

Using the encryption software 25 which the data owner has access to, the hash value h of the session number 140 is computed at Step 506 using the data owner's master key as an additional operand. The hash value h is then used as the public encryption (or session) key to encrypt at step 508 the data 23. Steps 502 to 508 are all carried out at the data owner's client computer 12 so that the secure hash value h (and thus the session key) is not accessible to other users.

At Step 510 the session number 140 is sent to the data storage service 19 via the Internet. The encrypted data 24 is then sent at Step 512 to the data storage service 19 also via the Internet.

Referring now to FIG. 5b, when a third party 28 wishes to access specific fields of the personal data belonging to the data owner 26, he sends at Step 513 a request to the data owner 26. The data owner then retrieves at Step 514 the appropriate session number 140 for the requested data from the data storage service 19 (namely the session number relating to the encryption of only the field of personal data which is to be made available to the requesting third party 28).

The data owner 26 then retrieves at Step 516 his master key. The session key is then regenerated at Step 518 using the encryption software 25 by inputting to the secure hash function the session number 138 and the master key. The data owner then passes at Step 520 the hash value (i.e., the session key) and the index value I to the third party 28. The third party logs on at Step 522 to the storage service 19 and retrieves the encrypted data 24 using the index value I and specifying the identity of the data owner 26. The third party then decrypts at Step 524 the encrypted data 24 using the hash value h.

As the session number 140 is unique for each field of data 24 that is stored at the data storage service 19, the hash value h is therefore also unique for each field of data 24. This has the effect of restricting the access of the third party 28 to just the data field 24 that he has requested from the data owner 26. Other data stored on the storage service 19 that belongs to the data owner can be downloaded by the third party, but he cannot decrypt it. The data owner can therefore have complete control of the amount of the centrally stored information which is made available to the third party wishing to see that information.

The Steps 513 to 524 of the secure hash method may be carried out via an open (i.e., an insecure) connection between the data owner's client computer 12 and the data storage service 19. As the data 24 is encrypted, if it is intercepted by an unauthorised party, the unauthorised party will not be able to decrypt the data.

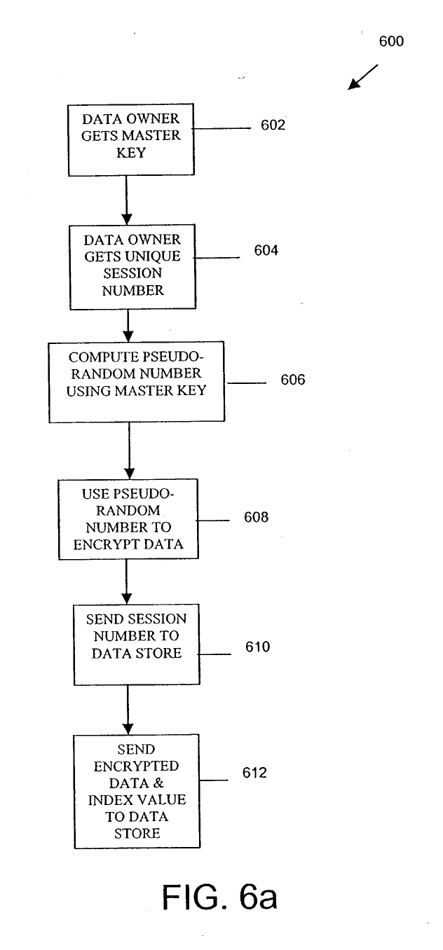

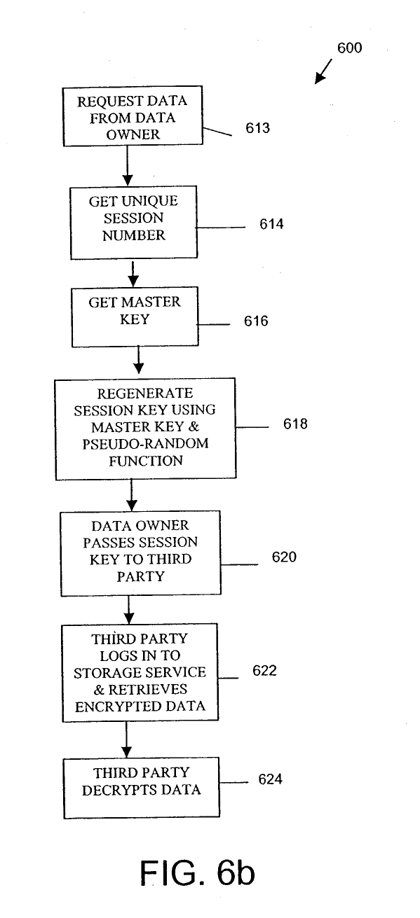

A second embodiment of the present invention utilising a second encryption/decryption technique whereby the session key is regenerated is now described with reference to FIGS. 6a and 6b. In this technique, the session key is generated using a secure pseudo-random function, rather than a hash-function as in the previously described embodiment.

With reference now to FIG. 6a, the second technique 600 commences with the data owner 26 retrieving at Step 602 his master key. As in the first technique 500, if the data owner 26 does not already have a master key, then one can be generated for him by the encryption software 25. The data owner 26 then gets at Step 604 the unique session number 140 from the session number generator 30. The next step of the method involves calculating at Step 606 a pseudo-random number R using the master key and the session number 140 as the pseudo-random number seeds. The order of Steps 604 and 606 may be interchanged if the session number generator 30 also generates the pseudo-random number, for example as is the case with a BBS generator. That is, each time the generator is used it may output the session number 140 as well as the pseudo-random number R.

The next step of the technique involves encrypting at Step 608 the data owner's personal data using the pseudo-random number R as the session key. The session number 140 is then sent at Step 610 to the data storage service 19 to be stored with the appropriate index value and data field. The encrypted data is then sent at Step 612 to the data storage service 19 along with the appropriate index value I. Steps 610 and 612 are carried out via a secure Internet connection.

Referring now to FIG. 6b, when a third party 28 wishes to access some specific parts of the data owner's personal data, he sends at Step 613 a request for that specific data to the data owner 26. The data owner then retrieves at Step 614 the appropriate session number 140 for the requested data from the data storage service 19.

The data owner 26 then retrieves at Step 616 his master key. The session key is then regenerated at Step 618 by the encryption software 25 to re-compute the pseudo-random number R using the master key and the session number 140 as the seeds. The data owner then passes at Step 620 the pseudo-random number R (i.e., the session key) to the third party 28, together with the appropriate index value I. The third party logs on at Step 622 to the storage service 19 and retrieves the encrypted data 24 using the index value I. The third party then decrypts at Step 624 the encrypted data 24 using the pseudo-random number R.

As the session number 140 is unique for each field of data 24 that is stored at the data storage service 19, the pseudo-random number R is therefore also unique for each field of data 24. As in the previous technique, this has the effect of restricting the access of the third party 28 to just the field of personal data 24 that he has requested from the data owner. Other fields of personal data stored on the storage service 19 that belong to the data owner can be downloaded by the third party, but cannot be decrypted. The data owner 26 can therefore control the amount of the centrally stored personal information which is made available to the third party wishing to see that information.

The Steps 613 to 624 of this technique may be carried out via an open (i.e., an insecure) connection between the data owner's client computer 12 and the data storage service 19. As the data 24 is encrypted, if it is intercepted by an unauthorised party, the unauthorised party will not be able to decrypt the data.

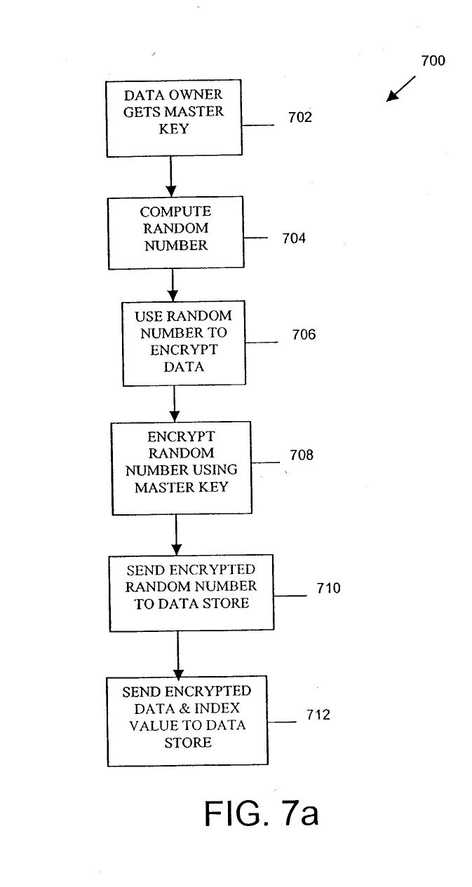

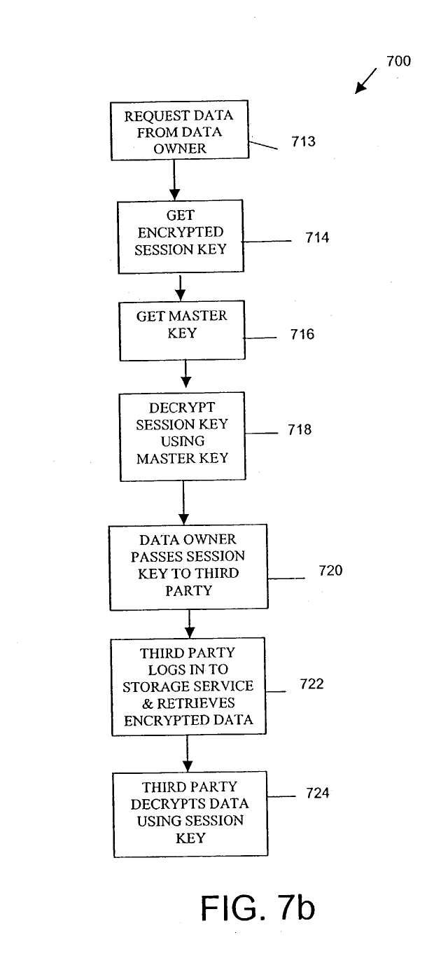

The third embodiment of the present invention utilising a third encryption/decryption technique 700 whereby the session key is stored and retrieved rather than regenerated is illustrated with reference to FIGS. 7a and 7b respectively. As seen from FIG. 7a, the first step 702 of the third technique 700 involves the data owner 26 retrieving his master key. He then computes at Step 704 a random or pseudo-random number R using a random/pseudo-random number generator (not shown). This pseudo-random or random number R is then used as the unique session key. The data 23 is encrypted at Step 706 using the randomly generated session key. Next, the randomly generated session key is encrypted at Step 708 using the master key, and then the encrypted session key is sent at Step 710 to the data storage service 19 via a secure connection. The final storage step comprises sending at Step 712 the encrypted data and the associated index value I to the data storage service also via a secure connection.

With reference now to FIG. 7b, the third party 28 requests at Step 713 specific personal data from the data owner 26, and this prompts the retrieval of the encrypted data 24 from the data storage service 19. The process of accessing and retrieving encrypted data 24 from the data storage service 19 commences with the data owner retrieving at Step 714 the encrypted session key from the data store 19. The data owner then retrieves at Step 716 his master key, and decrypts at Step 718 the session key using the master key. He then passes at Step 720 the decrypted session key and the index value I to the third party 28. The third party then logs on at Step 722 to the data storage service 19 and retrieves the encrypted data 24 using the index value I and specifying the identity of the data owner 26. The third party may then use the session key to decrypt at Step 724 the data 24 at his own leisure.

The presently preferred embodiments of the invention offer a very low cost but highly secure scheme that enables fine-grain privacy control of the data being stored. They also allow fine-grain selective disclosure of individual fields or elements of data to authorised parties without the risk of compromising the confidentiality of the other fields of stored personal data. Unlike existing solutions, the invention provides a simple generic scheme that can be used to implement platform-independent, Internet-based, open network storage systems. Because the provider of the storage service only sees encrypted data, it advantageously allows the storage provider to sell an information storage service to a large community of users without requiring the users to trust the storage provider with the confidentiality and integrity of the data.

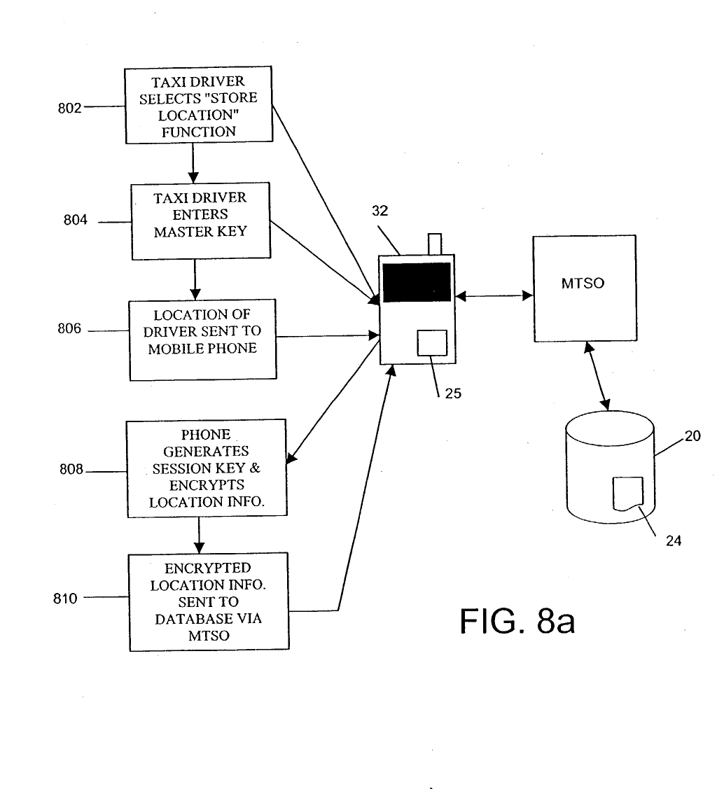

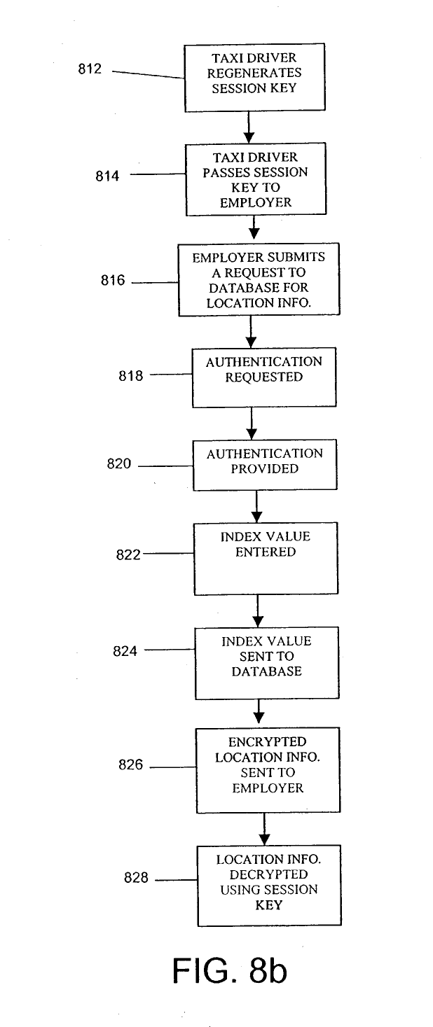

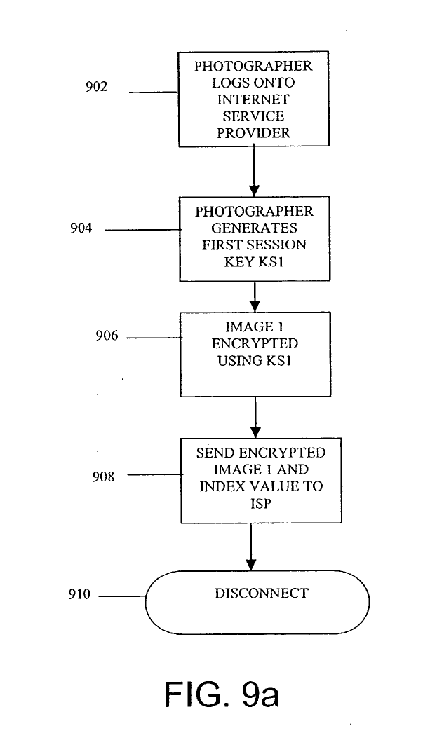

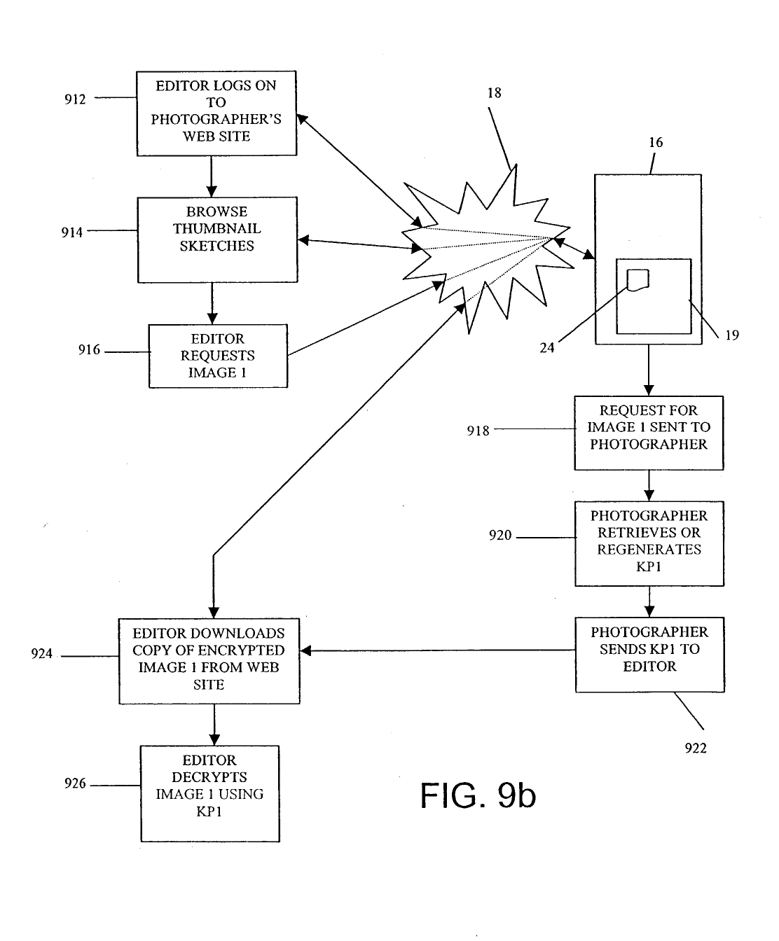

Two examples for which the presently preferred embodiments of the invention may be used are now described with reference to FIGS. 8 and 9. The first example relates to the secure storage and provision of information regarding the location of a user of a mobile (i.e., cellular) phone. The second example regards the secure storage and access of digital images.

Mobile phones operate within a network of cells, each of which has a radio transmitter located at its centre. When a phone is first switched on it listens for a System Identification Code (SID). The SID is a unique number that is assigned to each carrier/mobile phone operator. Along with the SID, the phone also transmits a registration request using the phone's low power radio transmitter. This request is picked up by the cell's transmitter and sent to the appropriate Mobile Telephone Switching Office (MTSO). An MTSO handles all of the phone's connections to land-lines, and also controls all of the base stations in the region. This way, the MTSO knows which cell the user of the phone is in when it wants to ring the phone.

This property of being able to locate the approximate position of a mobile phone (and therefore its user) may be used, for example, by a taxi driver to record his location at a particular time. This location information may then be subsequently used to confirm to his employer that he was in that particular location at the stated time. However, no data owner would be happy with the prospect of unauthorised third parties being able to access this type of information or even all of the taxi drivers movements being provided in response to a specific location/time request, and thus the invention provides a simple and low cost means for the taxi driver to securely store and control access to this information. The invention also means that the taxi driver does not have to keep paper records of the locations that he visits.

Referring now to FIG. 8a, the taxi driver has a mobile phone 32 that has encryption and key generation software 25 installed thereon. He also has his own personal secret master key Ks. When he wishes to store the location that he is in, he selects at Step 802 a “store location function” on his mobile phone 32 and enters at Step 804 the master key Ks. The MTSO transmits at Step 806 the location of the taxi driver to the phone 32, and the phone then generates at Step 808 a session key and encrypts the location information thereby giving encrypted data 24. This encrypted location data 24 is then transmitted at Step 810 to a central database 20 via the MTSO. The MTSO also sends to the central database 20 the session number 140 and the time at which the request for data storage was made. The time value can then be used as the identifying index value.

With reference to FIG. 8b, when the taxi driver wishes to confirm to his employer that he was in a particular location at a particular date and time, he regenerates at Step 812 the session key used to encrypt the location information using his master key. The taxi driver then passes at Step 814 the session key to his employer who submits at Step 816 a request for the encrypted information to the central database via the data storage service 19. This request may be made either through a Web site or by means of another phone such as a WAP enabled mobile phone. The data storage service 19 requests at Step 818 authentication of the caller's identity. This authentication may be provided by a password system, or even by the use of voice recognition software installed at the central database storage facility to prevent unauthorised access to the location information.

When the employer has authenticated at Step 820 his or her identity, he enters at Step 822 the identifying index value into his phone or Web browser together with the identity of the taxi driver. The time and date information is readily available from the taxi driver, as mobile phones keep a record of all of the calls made to, and from, the phone. The time and date information is then sent at Step 824 to the central database in order to retrieve the encrypted location data. The encrypted location information is sent at Step 826 to the employer 28 who then decrypts at Step 828 the location information 24 using the session key and the decryption software 27.

Even though the above example has been explained with reference to the regeneration of key information, it could be implemented using the third embodiment of the present invention whereby the session key is encrypted and stored and then subsequently retrieved and decrypted.

This type of location confirmation system could be implemented using a GPS (Global Positioning System) device rather than a mobile phone. Such devices are now affordable even for ordinary members of the public, and can pinpoint locations to within approximately one hundred metres.

The second example relates to a digital picture service that is provided by an ISP. The data owner 26 in this case is a freelance photographer who does not have the capacity for storing large amounts of digital data. He also wishes his photographs to be accessible to third parties 28 for use in publications, picture libraries etc. With reference now to FIG. 9a, the photographer 26 logs in at Step 902 to his Internet Service Provider that provides a storage facility 19 for storing data. Data in this case are digital images in any format which may be stored initially on the photographer's personal computer.

The photographer 26 then generates at Step 904 a first session key Ks1 for the first image that he wishes to encrypt and store. If he is storing information at the ISP for the first time, he creates a master key Kp, and downloads the encryption/decryption software from the ISP. The next step is the encryption at Step 906 of the first image using the session key Ks1. The encrypted first image is then sent at Step 908 to the data storage facility 19 via a secure Internet connection, along with an index value (such as “image1”) that is to be used to identify the encrypted image. If the photographer has a further image that he wishes to store, so he generates another session key Ks2 using the encryption software and repeats Steps 906 and 908. This process continues until the photographer has stored all of his images on his image bank record. The photographer now disconnects at Step 910 from the ISP.

As the data storage service 19 is provided by an ISP, the photographer may also have a Web site that is hosted by the ISP. The Web site may provide thumbnail images of all of the full images that are stored in encrypted form in the image bank record with the storage service 19, and may display the cost of retrieving the full image. The thumbnail sketches are of a lower resolution than the stored digital images in order that they are not suitable for inclusion in publications. These thumbnails may be transmitted to the ISP with the encrypted images at Step 908.

With reference now to FIG. 9b, a newspaper editor 28 would like a picture to use in her newspaper. She logs on at Step 912 to the photographer's Web site via her Web browser, and browses at Step 914 through the thumbnail images. When she sees a picture that meets her requirements, she requests at Step 916 the image by entering for example “image1” along with her personal details such as her name and email address in a form which may be displayed at the Web site. On submitting the form to the server 16, the details of this request are sent at Step 918 to the photographer 26. Assuming the photographer 26 is happy to give this image to the editor, he retrieves at Step 920 his master key Kp, regenerates or retrieves the session key Ks1 that was used to encrypt the image, and sends at Step 922 the session key Ks1 to the newspaper editor 28.

When the newspaper editor 28 has received this information, she logs into the Web site again, selects the picture she requires (image1) and downloads at Step 924 a copy of the encrypted image. She is then able to decrypt at Step 926 the encrypted image using the session key Ks1 and the decryption software which she has obtained from the photographer's Web site. As each stored encrypted image is encrypted with a different key, she will not be able to decrypt another image using the session key Ks1 that she now possesses. She therefore does not have the means of accessing the complete portfolio of publication-ready images without the photographer's permission. Another advantage of this system is that the photographer does not have to manage the distribution of his photographs himself—most of the work is done by the person requesting his images. This example illustrates that the invention is particularly suitable for storing master data where the owner of the data needs to have a high degree of privacy and full control of the disclosure of the data with minimised management overhead.

Having described a number of embodiments of the present invention, it is to be appreciated that the embodiments in question are exemplary only, and that variations and modifications such as will occur to those possessed of the appropriate skills and knowledge may be made without departure from the spirit and scope of the invention as set forth in the appended claims. For example, even though three different data encryption and decryption methods have been described, any other suitable encryption and decryption methods using a system of secret and public keys may be used.

The invention may also be used by mobile phone users to store information in a central database rather than on the individual's phone. As phone memory is limited, the individual can store encrypted data such as Web pages (if they have a WAP-enabled phone) or friends' personal details on a central database and retrieve the information at a later date using the key regeneration technique.

The invention may also be used in conjunction with other security measures such as server or personal certificates, to provide an additional level of security. These certificates may obtained from Web sites themselves, or from digital certificate providers such as VeriSign.

1. A method of providing to an individual selected personal data relating to an entity, the method comprising:
encrypting a plurality of fields of personal data relating to the entity, each data field being encrypted with a unique cryptographic key;
storing each of the encrypted data fields in a data record at a central location accessible to the entity and the individual; and
supplying to the individual a specific cryptographic decryption key associated with a respective one of the unique cryptographic keys which relates to a selected field of the entity's personal data, such that the individual is only able to decrypt the selected field of the entity's personal data by accessing the stored data record.

2. A method according to claim 1, wherein the encrypting step comprises generating the unique cryptographic key for a specific data field by use of a session number unique to the specific data field being encrypted and a master key of the entity, and using the generated unique cryptographic key to encrypt the specific data field.

3. A method according to claim 1, wherein the generating step comprises determining if the entity has a master key and assigning a master key to the entity if it does not have one.

4. A method according to claim 2, wherein the generating step comprises using a hash function to hash together the master key and the session number to generate the unique cryptographic key.

5. A method according to claim 2, wherein the generating step comprises using a pseudo-random number generation function to generate the unique cryptographic key using the master key and the session number as input seeds into the pseudo-random number generation function.

6. A method according to claim 1, wherein the encrypting step comprises generating the unique cryptographic key for a specific data field using a random-number/pseudo-random number generation function to generate the unique cryptographic key.

7. A method according to claim 2, wherein the storing step comprises storing the session number used for generation of the unique cryptographic key at the central location.

8. A method according to claim 2, wherein the supplying step comprises regenerating the unique cryptographic key for the specific data field to be supplied to the individual.

9. A method according to claim 8, wherein the regeneration step comprises retrieving the stored session number for the specific data field, recreating the unique cryptographic key by use of the retrieved session number and the master key of the entity.

10. A method according to claim 9, wherein the recreating step comprises using a hash function to hash together the master key and the session number to generate the unique cryptographic key.

11. A method according to claim 9, wherein the recreating comprises using a pseudo-random number generation function to generate the unique cryptographic key using the master key and the session number as input seeds into the pseudo-random number generation function.

12. A method according to claim 1, further comprising encrypting the unique cryptographic key using a master key of the entity.

13. A method according to claim 12, wherein the storing step comprises storing the encrypted cryptographic key at the central location.

14. A method according to claim 13, wherein the supplying step comprises retrieving the encrypted cryptographic key for the specific data field to be supplied to the individual, from a plurality of cryptographic keys stored at the central location, decrypting the cryptographic key using the master key before sending the cryptographic key to the individual.

15. A method according to claim 1, wherein the storing step comprises storing the encrypted data fields in a data record on a wide area network server computer.

16. A method according to claim 1, wherein the storing step comprises storing a unique index identifier with each encrypted data field in a data record at the central location such that a specific data field can be accessed by its index identifier.

17. A method according to claim 16, wherein the supplying step comprises supplying the index identifier corresponding to the selected data field, such that the individual can readily identify the required stored personal data at the central location.

18. A method according to claim 17, further comprising receiving from the individual a request to the central location for personal data relating to the entity.

19. A method according to claim 18, wherein the request receiving step comprises receiving the index identifier, and the method further comprises retrieving and sending the encrypted data field corresponding to the identifier to the individual.

20. A method according to claim 1, further comprising the individual receiving the encrypted data field and decrypting the same using the unique cryptographic key associated with the specific data field.

21. A method according to claim 1, further comprising associating a unique record identifier with each entity's data record stored at the central location, and providing a security challenge to the entity for editing access to its stored data record.

22. A method according to claim 1, wherein the supplying step is carried out in response to the entity receiving a request from the individual for specific personal data of the entity.

23. A method according to claim 1, wherein the encrypting and storing steps are carried out at spaced apart locations, and the method further comprises transmitting the encrypted personal data to the central location.

24. A method of securely storing data in, and retrieving data from, a data store, the method comprising:
encrypting a data record which comprises a plurality of data fields, each data field being encrypted using different key information;
storing the encrypted data record in the data store;
receiving a request for at least one of the data fields;
obtaining the key information for the requested at least one data field; and
sending the obtained key information and the requested encrypted data field(s) to a recipient so that the at least one data field of the data record may be decrypted.

25. A system for providing to an individual selected personal data relating to an entity, the system comprising:
an encrypting module for encrypting a plurality of fields of personal data, each encrypted field being encrypted with a unique cryptographic key;
a data store provided at a central location accessible to the entity and the individual for storing each of the encrypted data fields in a data record; and
a communications module for supplying a specific cryptographic decryption key associated with a respective one of the unique cryptographic keys which relates to a selected field of the entity's personal data to the individual such that, when the stored data record is accessed by the individual, the individual is only able to decrypt the selected field.

26. A system according to claim 25, wherein the encrypting module and the communications module are provided at the entity's location, and the central location is remote from the entity's location.

27. A system for providing to an individual selected personal data relating to an entity, the system being provided at a central location accessible to the entity and the individual and comprising:
a communications module for receiving a plurality of encrypted fields of personal data, each encrypted field being encrypted with a unique cryptographic key; and
a data store for storing each of the encrypted data fields in a data record;
wherein the communications module is arranged, in response to a request from the individual for specific encrypted personal data, to retrieve the required data field and transmit the same to the individual for decryption using the field specific cryptographic key that has previously been sent to the individual.

28. A method of providing to an individual selected personal data relating to an entity, the method comprising:
generating a plurality of unique cryptographic keys for encrypting a plurality of fields of personal data relating to an entity, by use of a session number unique to the personal data field being encrypted, and a master key of the entity;
encrypting each personal data field using one of the plurality of unique cryptographic keys;
storing each encrypted data field in a data record at a central location accessible to the entity and the individual; and
supplying to the individual a specific cryptographic decryption key associated with a respective one of the unique cryptographic keys which relate to a selected field of the entity's personal data, such that the individual is only able to decrypt the selected field of the entity's personal data by accessing the stored data record.

29. A method of providing to an individual selected personal data relating to an entity, the method comprising:
generating a plurality of unique cryptographic keys for encrypting a plurality of fields of personal data relating to the entity by using a hash function to hash together a master key of the entity and a session number unique to the personal data field being encrypted;
encrypting each personal data field using one of the plurality of unique cryptographic keys;
storing at a central location accessible to the entity and the individual each session number used for generation of each unique cryptographic key, and each encrypted data field in a data record;
receiving a request at the central location for selected personal data relating to the entity;
retrieving the stored session number for the specific data field to be supplied to the individual from the plurality of session numbers stored at the central location;
recreating the unique cryptographic key for the specific data field to be supplied to the individual using the hash function to hash together the master key of the entity and the retrieved session number;
supplying to the individual the recreated cryptographic key which relates to the selected field of the entity's personal data, for use as the decryption key, such that the individual is only able to decrypt the selected field of the entity's encrypted personal data by accessing the stored data record.

30. A method according to claim 28, wherein the generating step comprises using a pseudo-random number generation function to generate the unique cryptographic key using the master key and the session number as input seeds into the pseudo-random number generation function.

31. A method of providing to an individual selected personal data relating to an entity, the method comprising:
generating a plurality of unique cryptographic keys for encrypting a plurality of fields of personal data relating to the entity by using a pseudo-random number generation function using a master key and a session number unique to the specific data field being encrypted as input seeds into the pseudo-random number generation function;
encrypting each personal data field using one of the plurality of unique cryptographic keys;
storing at a central location accessible to the entity and the individual each session number used for generation of each unique cryptographic key, and each encrypted data field in a data record;
receiving a request at the central location for selected personal data relating to the entity;
retrieving the stored session number for the specific data field to be supplied to the individual from the plurality of session numbers stored at the central location;
recreating the unique cryptographic key for the specific data field to be supplied to the individual by using the master key and the retrieved session number as input seeds into the pseudo-random number generation function;
supplying to the individual the recreated cryptographic key which relates to the selected field of the entity's personal data, for use as the decryption key, such that the individual is only able to decrypt the selected field of the entity's encrypted personal data by accessing the stored data record.

32. A method of providing to an individual selected personal data relating to an entity, the method comprising:
generating a plurality of unique cryptographic keys for encrypting a plurality of fields of personal data relating to the entity by the use of a random number/pseudo-random number generation function;
encrypting each personal data field using one of the plurality of unique cryptographic keys;
encrypting each unique cryptographic key using a master key of the entity;
storing at a central location accessible to the entity and the individual each of the encrypted unique cryptographic keys, and the encrypted data fields in a data record;
receiving a request at the central location for selected personal data relating to the entity;
retrieving the encrypted cryptographic key for the specific data field to be supplied to the individual, from the plurality of cryptographic keys stored at the central location;
decrypting the cryptographic key using the master key;
sending the cryptographic key to the individual for use as a decryption key for decrypting a selected field of the entity's personal data, such that the individual is only able to decrypt the selected field of the entity's personal data by accessing the stored data record.
